(19) United States
(12) Patent Application Publication
(10) Pub. No.: US 2008/0272904 A1
(43) Pub. Date: Nov. 6, 2008

(54) Signalling Method

(76) Inventor: Eric Atherton, Oxfordshire (GB)

Correspondence Address: MADAN, MOSSMAN & SRIRAM, P.C., 2603 AUGUSTA DRIVE, SUITE 700, HOUSTON, TX, 77057-5662, US

(21) Appl. No.: 11/570,941

(22) PCT Filed: Jun. 24, 2005
(86) PCT No.: PCT/GB2005/002502

§ 371 Date: Dec. 19, 2006

(30) Foreign Application Priority Data
Jun. 26, 2004 (GB) 0414352.5

(51) Int. Cl. G08B 1/08

(52) U.S. Cl. 340/538.11

(57) ABSTRACT

An electrical signalling system comprises a modulator arranged to accept information and encode that information in an alternating signal containing repeated rising and falling edges, the encoding being by way of the time between consecutive rising and falling edges a transmission path for the signal from the modulator to a demodulator, wherein the modulator is arranged to precede a data signal with a reference signal of a known time, and the demodulator is arranged to detect that reference signal and calculate a calibration error therefrom. The demodulator can record the calibration error and subtract this from subsequent data signals. The demodulator can alternatively (or in addition) adjust the threshold for future signals, on the basis of the calibration error. This is particularly suited to inductive transmission paths such as a three-phase electrical supply cable leading to downhole sensors in the oil and gas extraction industries.

### FIELD OF THE INVENTION

The present invention relates to a signalling method.

### BACKGROUND ART

Existing signalling methods used for the return of information from a downhole sensor, for example in the oil and gas extraction industries, rely on the transmission of signals along suitable conductors. These conductors must traverse the entire depth of the hole in which the transducer is located. There is significant cost associated with installing a downhole conductor, and therefore it is desirable to multiplex the downhole sensor signals along other conductors that are also present in the borehole.

It has previously been proposed to employ the three-phase conductors used for electrical supply to downhole motors that may be located in the wellbore. It is a characteristic of a balanced three-phase electrical supply that after passing through the load (such as a motor), the conductors can then be grounded at a neutral point. The neutral point will, in the absence of faults in the three-phase supply, exist at substantially zero volts, with respect to the surrounding earth or chassis potential. A mirror of the neutral point can then be constructed above ground through the use of three inductive loads, and in this way a conductive path can be created between the neutral point on the surface and the downhole neutral point, with the return signal going through the downhole casing or tubing in the wellbore. Signals can be sent around this conductive path.

However, if a fault should occur in the three-phase supply then the downhole neutral point would be exposed to significant voltages. Accordingly, a downhole inductor is commonly placed in series with the neutral point prior to connection to the signalling instrumentation. In association with a downhole capacitor, a low pass filter is thus created, which limits the ingress of the high alternating voltages that power the downhole motor. This inductor and capacitor combination will tend to limit the speed at which the applied signal can be varied and hence the bandwidth of this transmission path. Typically, given the voltages involved in this context, an inductance will be required which will impose a minimum settle time of the order of up to one second. That is, after an abrupt change in the applied voltage at the downhole neutral point, there will be a period of approximately ½ second during which the voltage at the surface neutral point will be unstable before it settles at the new voltage level. To read that new level, a wait of about a second will be required. Prior to this time, the measured voltage at the surface neutral point will be variable as a result of the inductor.

Known signalling systems such as U.S. Pat. No. 5,539,375 use voltage or current levels to encode information, but these methods suffer from this long settling time caused by the above mentioned inductors in the signal path. In addition, electrical interference from the pump power can cause the current or voltage levels to be disturbed, degrading the signal quality if analogue encoding methods are used, or degrading the data transmission rate if digital encoding methods are used.

### SUMMARY OF THE INVENTION

The present invention seeks to overcome this limitation and provide a signalling system that can cope with such an extremely low quality transmission path, provide a usable bandwidth, and substantially mitigate the effects of electrical interference.

It therefore provides an electrical signalling system, comprising a modulator arranged to accept information and encode that information in an alternating signal containing repeated rising and falling edges, the encoding being by way of the time between consecutive rising and falling edges a transmission path for the signal from the modulator to a demodulator, wherein the modulator is arranged to precede a data signal with a reference signal of a known time, and the demodulator is arranged to detect that reference signal and calculate a calibration error therefrom.

Clearly, the measurement can be between a rising edge followed by a later falling edge, or between a falling edge and a later rising edge.

The demodulator can record the calibration error and subtract this from subsequent data signals. A negative calibration error will then of course increase the output signal. We have found that the error in signals of this type, i.e. low bandwidth pulse width modulated signals transmitted along inductive paths, tends to be systematic in that the rising and falling edges are not sharp, but have a distinct gradient. As a result, a threshold detector will give a result that is sensitive to the chosen threshold and this effect dominates the error in the signal. However, as the profile of the rising and falling edges is substantially independent of the time between them, this threshold-related error is systematic in that it is substantially the same absolute value regardless of the pulse width. It can thus be corrected by a consistent addition or subtraction.

The demodulator can alternatively adjust the threshold for future signals, on the basis of the calibration error. The demodulator can store an image of the reference signal and adopts a threshold for which the calibration error is substantially zero, or it can correct the threshold approximately and check this new value when the next reference signal arrives.

These can be combined, for example in a system that receives a reference signal, notes an error and applies this to the subsequent data signals as a correction and then, prior to arrival of the next reference signal, adjusts the threshold to a new value. In this way, the data signals between reference signals are subject to an error correction, but the threshold is set to a more accurate value prior to the next reference signal and the next iteration.

The transmission path can be imperfect, for example inductive, without impairing the efficiency of such a system, although this will place limits on the available bandwidth. The system is capable of sending recognisable signals along a three-phase electrical supply cable. In general, equipment attached to the cable will provide noise on top of the intended signal, but the system can cope with this.

The invention is particularly applicable to the supply of information from downhole sensors in the oil and gas extraction industries. These sensors must transmit the signals over a long transmission path, often using cables optimised for survival in the environment rather than for ideal electrical characteristics.

Multiple sources of data can be included consecutively by transmitting in a predetermined sequence. Thus, a complete data packet might, for example, include a reference signal, a pressure signal, and then a temperature signal.

The data can be digitally encoded using “bins”, i.e. a specific range of times that correspond to a specific value of the input information. For example, a specific output of the transducer could be coded as any signal between 410 and 414 ms. In this case, the system will seek to send a 412 ms signal, and provided the error rate is less than 2 ms, preferably less than 1 ms, there will be no uncertainty in the received signal at the surface. The bins can all be of identical width, or can have a variable width such that the accuracy of the system is greatest in its usual working parameters.

A double binning arrangement can also be used. For example, if it is desired to send a value of (for example) 1057, a first signal could indicate that the information is in a range 1000-1999 and a second signal could specify 57 as opposed to 56 or 58. By adding the signals together, the intended output of 1057 is obtained. This can provide greater efficiency in the usage of bin sizes. It can be arranged that a digitised signal (as above) shows the coarse level (eg. 1000, 2000, 3000 etc.) followed by further signal (analogue or digital) for the fine resolution. This can be of great benefit. If for example the “noise” in the signal transmission system is 1 ms, and the time between edges varies from 1 second to 2 seconds, according to the measured signal, then a 0-10,000 psi measured value will be encoded in a 0 to 1000 ms window, with 1 ms of noise. This would give a noise of 10 psi. However, if a coarse level is transmitted first that specifies the coarse range (0-999, 1000-1999 etc.), then a subsequent analogue signal need only span from 0-1000 psi and hence the overall noise would be 1 psi.

The present invention also offers a further improvement in the design of such systems. Thus, it provides an electrical signalling system, comprising a modulator arranged to accept information from a plurality of sources and encode that information as a pulse width modulated signal, wherein information from the plurality of sources is encoded as subsequent pulse widths, the information from at least one sensor is encoded such that an increasing value corresponds to an increasing pulse width, and the information from at least one other sensor is encoded such that an increasing value corresponds to a decreasing pulse width.

In this way, the total time required for transmission of both signals, from the two or more sensors, can be made largely constant. This applies particularly where the sensors sense related parameters, such as the same parameter or where they are redundant pairs. As the pressure or temperature rises, one sensor will prompt a longer pulse whereas the other will prompt a shorter pulse. Thus, the total time for both sensors will be largely the same. This is useful, In that assuming the pulses to vary between 1 and 2 seconds, it prevents a variation in the acquisition time of between 2 and 4 seconds. Instead, the apparatus can be designed to cope with a relatively stable acquisition time of 3 seconds.

This additional aspect of the invention can be used together with the above-described aspect in which the information is encoded as the time between a rising edge and a falling edge. However, this is not essential and this aspect is equally applicable to other encoding methods, such as those in which the information is encoded as the time between a rising edge and a later rising edge. An example of the latter is found in our earlier application No: GB0326055.1 filed on 7 Nov. 2003.

### BRIEF DESCRIPTION OF THE DRAWINGS

An embodiment of the present invention will now be described by way of example, with reference to the accompanying figures in which;

FIG. 1 shows a downhole instrumentation system;

FIG. 2 shows the signal from the instrumentation system; and

FIG. 3 shows the effect of noise on the signal.

### DETAILED DESCRIPTION OF THE EMBODIMENTS

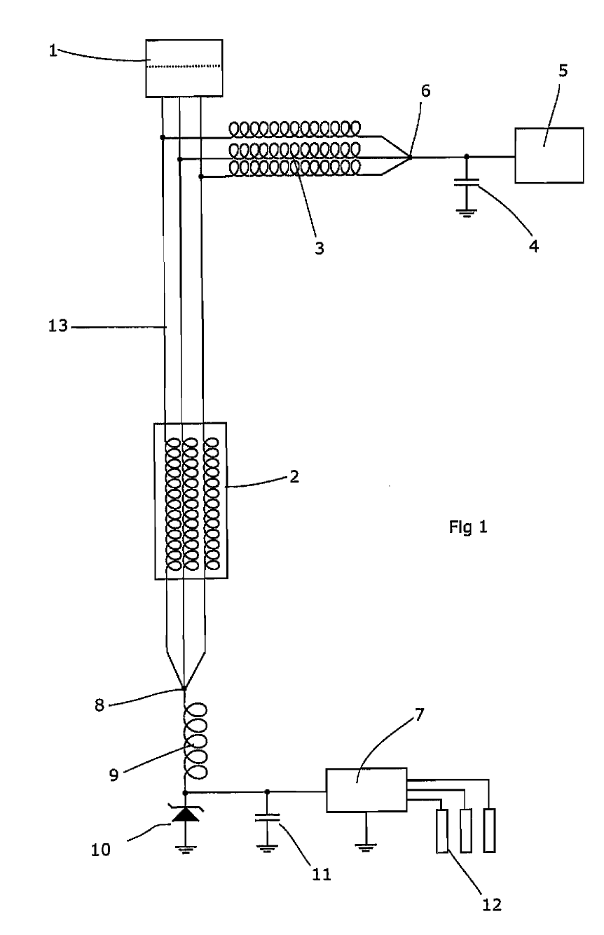

FIG. 1 shows a downhole motor 2 connected via a downhole 3-phase power cable 13 to a surface isolated power supply 1. This system is used to assist the flow of oil up the well in a generally known manner.

A downhole instrument, consisting of downhole electronics 7, sensors 12, capacitor 11, zener diode 10 and downhole inductor, 9, is attached to the neutral point 8 of the downhole motor 2.

Surface electronics 5 are attached to surface neutral point 6, which is formed by joining the three surface inductors 3 together to make the neutral point 6. The surface conductors 3 are electrically connected to the downhole motor cable 13.

Hence, the downhole electronics 7 can communicate via inductor 9, motor 2, cable 13 and surface inductors 3 to the surface electronics, 5.

The surface electronics 5 provide a steady direct current (DC) voltage, using well known methods, and the downhole electronics 7 sink a controlled amount of current, using well known methods. The amount of current is under the control of electronics, 7. Variations in this current cause a variation in the current drawn from the surface electronics 5, which therefore monitors this current. Accordingly, a line of communication is established.

Downhole electronics 7 is attached to sensors 12. The readings from these sensors 12 are digitised by the electronics 7, which then encodes the readings by modulating the current. This is in turn sensed by surface electronics 5.

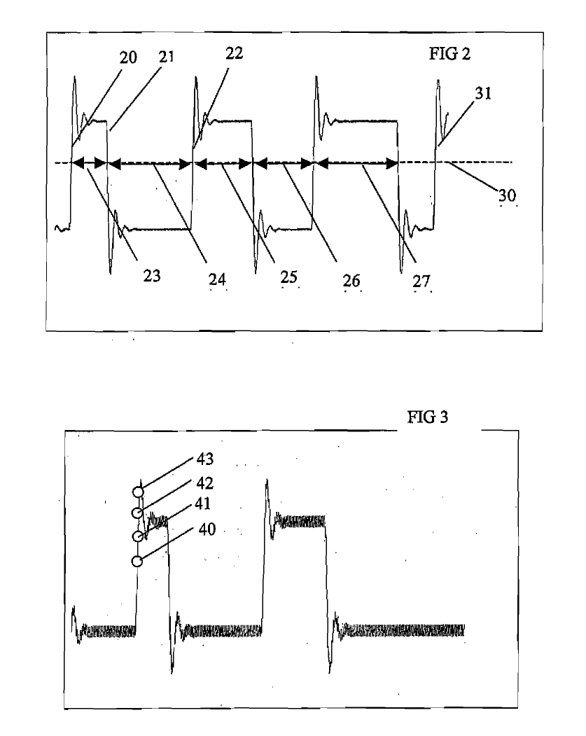

A typical current signal generated by the downhole electronics 7 and received by the surface electronics 5 is shown in FIG. 2, in which a positive edge 20 is followed by a negative edge 21 after a time interval 23. In a similar way the negative edge 21 is followed by further positive edge 22 after a further time interval 24. Further time intervals 25, 26 and 27 follow and are defined in similar fashion. The surface electronics 5 measures the time intervals 23, 24, 25, 26 and 27 by setting a threshold level (shown as dotted line 30). The signal pattern is continuously repeated, with positive edge 31 representing the start of the next sequence. Information from the sensors 12 is encoded in the time intervals 24, 25, 26 and 27.

Time interval 23 is always 0.75 seconds, as generated by the downhole electronics 7. Due to the inductive nature of the transmission path between the downhole electronics 7 and the surface electronics 5, the positive edge 20 does not rise instantaneously and so has a finite upwards slope. Likewise, the negative edge 21 does not fall instantaneously, and has a finite downwards slope. It will be apparent that if the threshold level 30 is set too low by the surface electronics 5, the interval 23 as measured by the surface electronics 5 will be longer than 0.75 seconds. If the threshold level 30 is set too high by the surface electronics 5, then the interval 23 measured by the surface electronics 5 will be less than 0.75 seconds. The surface electronics 5 actively adjusts the threshold level 30 so that the measured interval 23 is as close to 0.75 seconds as possible, by raising the threshold level 30 for the next sequence, if the measured interval 23 is greater than 0.75 seconds, or lowering the threshold level 30 for the next sequence if the measured interval 23 is less than 0.75 seconds. The threshold level 30 is, in this example, held constant during each sequence.

The sensors 12 comprise two pressure sensors, P1 and P2, and two temperature sensors, T1 and T2. Intervals 24, 25, 26 and 27 encode the instantaneous value of sensors P1, P2, T1 and T2 respectively. Prior to decoding each interval, the surface electronics 5 adjusts the measured value of each interval 24, 25, 26 and 27 according to the measured value of the reference interval 23. For example, if the measured value of the reference interval 23 was 0.755 seconds, then 0.005 seconds would be subtracted from each of the measured intervals 24, 25, 26 and 27.

P1 and T1 are encoded so that a 0% reading from these sensors generates a 1.000 second time interval 24 and 26 (respectively), and a 100% reading from these sensors generates a 2.000 second interval. Intermediate percentage readings generate intermediate intervals, the mapping from percentage readings to time intervals being (in this case) linear. P2 and T2 are encoded so that a 100% reading from these sensors generates a 1.000 second interval 25 and 27 (respectively), and a 0% k reading from these sensors generates a 2.000 second interval. Intermediate percentage readings generate intermediate intervals, the mapping from percentage readings to time intervals being linear, in this example.

Hence it will be seen that a large pressure on P1 and P2 will generate a large value for interval 24, and a small value for interval 25. A small pressure on P1 and P2 will generate a small value for interval 24, and a large value for interval 25. Although P1 and P2 are not identical in typical downhole situations, they will be similar and by inverse-mapping the relationship between the values and the intervals for P2 and T2 in this way, the total time for the transmission of a complete sequence is more constant for varying pressures and temperatures, than would otherwise be the case if all the sensors were mapped directly to intervals.

An alternative method is shown in FIG. 3, In which positive edge 20 is shown in the presence of electrical noise and sampled at 4 different sample points 40 41 42 and 43. This data may be obtained by sampling using a fast analogue to digital converter, or using 4 threshold levels and compactors, using well-known methods. The precise position of the edge 20 may then be constructed in a microprocessor using standard line fitting methods. In high electrical noise environments, this method of detecting the edge 20 yields more precise and noise free results, rather than sampling just one point on the edge.

It will of course be understood that many variations may be made to the above-described embodiment without departing from the scope of the present invention.

1. An electrical signalling system, comprising:
(a) a modulator arranged to accept input information and encode the input information in an alternating signal containing repeated rising and falling edges, the encoding being by way of a time between consecutive rising and falling edges; and
(b) a transmission path for the alternating signal from the modulator to a demodulator, wherein the modulator is arranged to precede a data signal with a reference signal of a known time, and the demodulator is arranged to detect the reference signal and calculate a calibration error therefrom.

2. An electrical signalling system according to claim 1 wherein the demodulator records the calibration error and subtracts this the calibration error from subsequent data signals.

3. An electrical signalling system according to claim 1 wherein the demodulator ascertains an edge by comparing an instantaneous alternating signal to a threshold value.

4. An electrical signalling system according to claim 3 wherein the demodulator adjusts the threshold value for future signals on the basis of the calibration error.

5. An electrical signalling system according to claim 4 wherein the demodulator stores an image of the reference signal and adopts a value for the threshold value for which the calibration error is substantially zero.

6. An electrical signalling system according to claim 1 wherein the transmission path is imperfect.

7. An electrical signalling system according to claim 1 wherein the transmission path is inductive.

8. An electrical signalling system according to claim 1 wherein the transmission path is a three-phase electrical supply cable.

9. An electrical signalling system according to claim 8 wherein the three-phase electrical supply cable leads to downhole equipment for extraction of oil or gas.

10. An electrical signalling system according to claim 1 wherein the modulator includes multiple sources of data consecutively.

11. An electrical signalling system according to claim 1 wherein the input information is encoded such that a specific range of pulse times correspond to one of (i) a specific value and (ii) a range of values of the input information.

12. An electrical signalling system according to claim 11 wherein the range of values of the input information are of identical width.

13. An electrical signalling system according to claim 11 wherein the range of values of the input information are of variable width.

14. An electrical signalling system according to claim 1 wherein a first signal indicates a coarse range of the input information and a second signal indicates a fine value of the input information.

15. An electrical signalling system according to claim 14 wherein the first signal and the second signal are encoded according to different protocols.

16. An electrical signalling system, comprising;
(a) a modulator arranged to accept input information from a plurality of sources and encode the input information as a pulse width modulated signal; and wherein:
(i) the input information is encoded as subsequent pulse widths;
(ii) the information from one or more sensors is encoded such that an increasing value corresponds to an increasing pulse width; and
(iii) the information from at least one other sensor is encoded such that an increasing value corresponds to a decreasing pulse width.

17. An electrical signalling system according to claim 16 wherein the one or more sensors includes at least two sensors.

18. An electrical signalling system according to claim 17 wherein the at least two sensors sense related parameters.

19. An electrical signalling system according to claim 17 wherein the at least two sensors sense the same parameter.

20. An electrical signalling system according to claim 17 wherein the at least two sensors are a redundant pair.

21. An electrical signalling system according claim 16 wherein at least one of the one or more sensors is a pressure sensor.

22. An electrical signalling system according claim 16 which the wherein at least one of the one or more sensors is a temperature sensor.

23. An electrical signalling system according to claim 16 wherein the input information is encoded as a time between a rising edge and a falling edge.

24. An electrical signalling system according to claim 23 wherein the input information from the at least one sensor of the one or more sensors is encoded as a time between a rising edge and a falling edge and the input information from at least one other sensor of the one or more sensors is encoded as a time between the falling edge and a later rising edge.

25. An electrical signalling system according to claim 16 wherein the input information is encoded as a time between a rising edge and a later rising edge.

26. An electrical signalling system according to claim 25 wherein the input information from the at least one sensor of the one or more sensors is encoded as a time between a rising edge and a later rising edge, and the input information from the at least one other sensor of the one or more sensors is encoded as a time between a falling edge and a later falling edge.

27. (canceled)
